(19) United States
(12) Patent Application Publication
(10) Pub. No.: US 2018/0089635 A1
(43) Pub. Date: Mar. 29, 2018

(54) APPOINTMENT CONNECTION

(71) Applicant: Hewlett-Packard Development Company, L.P., Houston, TX (US)

(72) Inventors: Stephen Hinton, Cypress, TX (US); Sarit Williams, Cypress, TX (US); Rick Thai Pham, Houston, TX (US)

(21) Appl. No.: 15/277,188

(22) Filed: Sep. 27, 2016

(51) Int. Cl. G06Q 10/10

(52) U.S. Cl. CPC G06Q 10/1095

(57) ABSTRACT

Examples associated with appointment connection are described. One example includes receiving an unprompted signal from a dedicated hardware input. The dedicated hardware input is associated with initiating a call. A calendar is scanned for a temporally relevant appointment. The temporally relevant appointment is scanned for connection information regarding the appointment. A connection associated with the temporally relevant appointment is established using the connection information.

### BACKGROUND

A variety of technologies are used to connect users across vast distances so that the users can communicate, collaborate, interact, and so forth. These technologies may include, for example, teleconferencing technologies, video conferencing technologies, voice over internet protocol technologies, chat applications, and so forth. Often, users schedule meetings with one another using calendar applications. Appointments stored by the calendar applications sometimes include connection information associated with these communication technologies.

### BRIEF DESCRIPTION OF THE DRAWINGS

The present application may be more fully appreciated in connection with the following detailed description taken in conjunction with the accompanying drawings.

FIG. 1 illustrates a flowchart of example operations associated with appointment connection.

FIG. 2 illustrates another a flowchart of example operations associated with appointment connection.

FIG. 3 illustrates an example system associated with appointment connection.

FIG. 4 illustrates an example conferencing system associated with appointment connection.

FIG. 5 illustrates an example computing device in which example systems, and methods, and equivalents, may operate.

### DETAILED DESCRIPTION

Systems, methods, and their equivalents associated with appointment connection are described. When a user seeks to connect to an online meeting, teleconference, video conference, and so forth, frequently, the user is responsible for opening their calendar and connecting to the call or initiating an application that connects to the call. Instead, techniques disclosed herein allow a user to provide a signal via a dedicated input that causes automatic connection to an impending or already started meeting. Using the dedicated input may save the user time and/or energy figuring out how to connect to their next meeting by eliminating the time the user spends determining which application to use, who to call, how to call or connect, and so forth.

After the user activates the input, the user's calendar may be scanned for a temporally relevant appointment, and connection details may be extracted from the appointment. Subsequently, an appropriate meeting connection may be established based on the connection details by, for example, launching an application identified by the connection details. In another examples, a conferencing room configured with a reservation system may similarly provide a dedicated input that allows meeting details associated with a present or impending reservation of the conference room to be scanned for connection information. This connection information may be used to automatically initiate and/or connect a conferencing technology within the conference room to, for example, another conference room employing a compatible conferencing technology.

It is appreciated that, in the following description, numerous specific details are set forth to provide a thorough understanding of the examples. However, it is appreciated that the examples may be practiced without limitation to these specific details. In other instances, methods and structures may not be described in detail to avoid unnecessarily obscuring the description of the examples. Also, the examples may be used in combination with each other.

“Module”, as used herein, includes but is not limited to hardware, firmware, software stored on a computer-readable medium or in execution on a machine, and/or combinations of each to perform a function(s) or an action(s), and/or to cause a function or action from another module, method, and/or system. A module may include a software controlled microprocessor, a discrete module, an analog circuit, a digital circuit, a programmed module device, a memory device containing instructions, and so on. Modules may include gates, combinations of gates, or other circuit components. Where multiple logical modules are described, it may be possible to incorporate the multiple logical modules into one physical module. Similarly, where a single logical module is described, it may be possible to distribute that single logical module between multiple physical modules.

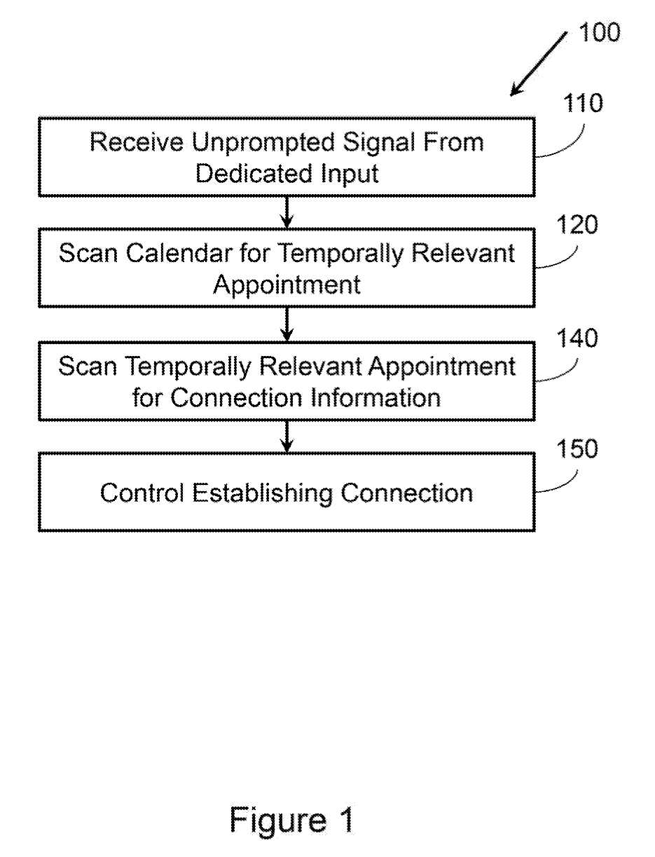

FIG. 1 illustrates an example method 100 associated with appointment connection. Method 100 may be embodied on a non-transitory processor-readable medium storing processor-executable instructions. The instructions, when executed by a processor, may cause the processor to perform method 100. In other examples, method 100 may exist within logic gates and/or RAM of an application specific integrated circuit (ASIC). In various examples, method 100 may be performed by, for example, a telephone, a computer with attached input system, a conferencing system embedded in a conference room, and so forth.

Method 100 includes receiving a signal at 110. The signal may be received from a user. The signal may be an unprompted signal. As used herein, an unprompted signal may be a signal that is received without previously requesting the signal. By way of illustration, an unprompted signal may be received, for example, from a remote device without previously contacting the remote device specifically for the signal. Alternatively, the unprompted signal may be received from a user via an input device without previously, for example, requesting an action from the user via an auditory and/or visual signal (e.g., a screen popup). Consequently, method 100 may be user initiated.

The signal may be received via a dedicated hardware input. As used herein, the dedicated hardware input may be a key, button, or other input, that is preconfigured to provide a specific known signal. While in some cases that signal may be specifically associated with initiating a call, in some cases the signal may be a generic signal from a known hardware input that an application has been configured to interpret as a user seeking to initiate a call. Thus, the dedicated hardware input may be a key on a keyboard whose function has been defined based on an application installed on a system to which the keyboard is attached. In other examples, such as where a system performing method 100 is a dedicated conferencing system, the system may include a dedicated input installed thereon configured to cause the system to connect to a call.

Method 100 also includes scanning a calendar at 120. The calendar may be associated with, for example, a user operating a system performing method 100, a conference room into which a system performing method 100 is installed, and so forth. The calendar may be scanned for a temporally relevant appointment. As used herein, a temporally relevant appointment may be appointment that is past its scheduled initiation time, an appointment with an impending initiation time, and so forth. Thus, the temporally relevant appointment may be an appointment that is starting soon or is ongoing at the time the dedicated hardware input is activated. What appointments are considered temporally relevant may depend on, for example, how a system performing method 100 is configured, whether an appointment is ongoing, how soon an appointment is scheduled to start, urgency information associated with appointments, and so forth.

Method 100 also includes scanning the temporally relevant appointment at 140. The temporally relevant appointment may be scanned for connection information regarding the appointment. The connection information may include, for example, a telephone number, an email address, conferencing information, a username, a password, a uniform resource locator (URL) address, an application identifier, and so forth. Thus, connection information may depend on a communication technology that is intended to be used during the appointment.

Method 100 also includes establishing a connection at 150. The connection may be associated with the temporally relevant appointment. The connection may be established using the connection information. In examples where the connection information identifies an application, controlling establishing the connection may include launching the application with parameters that cause the application to establish the connection. By way of illustration, if the temporally relevant appointment specifies a conference call to join via a specific application, establishing the connection may include controlling initiation of the specific application, controlling an open instance of the specific application to join the conference call, and so forth.

To illustrate an example operation of method 100, method 100 may begin after a user presses a dedicated key on their keyboard to join a call. The user may press this because the user knows that they have a meeting scheduled to start in the next few minutes. At this point, the user's calendar may be scanned for appointments that are starting soon or have started recently. When one is found, that appointment may be scanned for connection details. In this example, these connection details may specify an application associated with a conference call, as well as connection information (e.g., login information) for the conference call. Subsequently, the application associated with the conference call may be launched, and controlled to connect to the conference call using the connection information.

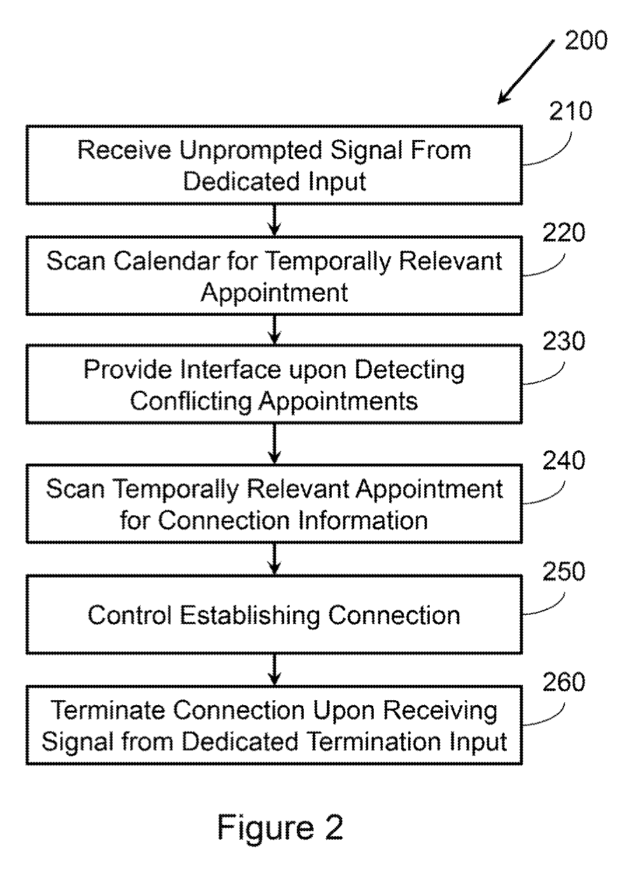

FIG. 2 illustrates a method 200 associated with appointment connection. Method 200 includes several actions similar to those described above with reference to method 100 (FIG. 1). For example, method 200 includes receiving an unprompted signal at 210, scanning a calendar for a temporally relevant appointment at 220, scanning the temporally relevant appointment for connection information at 240, and controlling establishing a connection at 250.

Method 200 also includes providing an interface for selecting the temporally relevant appointment at 230. The interface may be provided upon detecting conflicting appointments. Conflicting appointments may be appointments that could both or all be considered temporally relevant appointments and are scheduled to occur concurrently in the calendar. By way of illustration, conflicting appointments may include two (or more) appointments scheduled to start at or near the same time, an appointment scheduled to start while an appointment is ongoing, and so forth.

Method 200 also includes terminating the connection at 260. The connection may be terminated upon receiving a signal from a dedicated hardware termination input. The dedicated hardware termination input may be, for example, an input separate from the dedicated hardware input used at action 210, the same input, and so forth. The form of dedicated hardware termination input may depend on the type of system performing method 200.

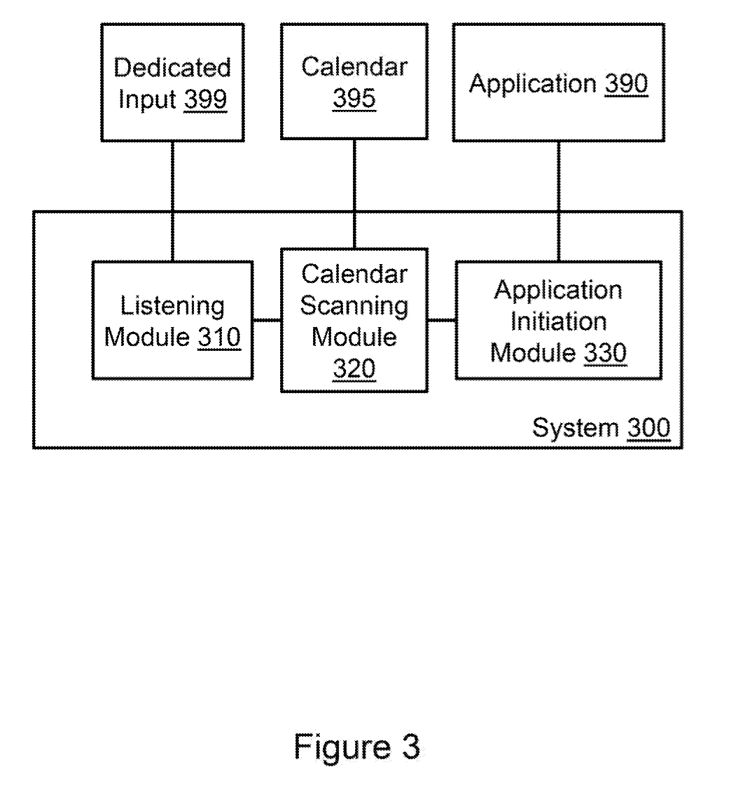

FIG. 3 illustrates a system 300 associated with appointment connection. System 300 includes a listening module 310. Listening module 310 may detect a control from a user via a dedicated hardware input 399. The control may indicate the user seeks to activate a communication application 390 associated with a temporally relevant appointment. In various examples, communication application 390 may be a voice over internet protocol (VoIP) application, a chat application, a teleconferencing application, a video conferencing application, a telephone application, and so forth.

System 300 also includes a calendar scanning module 320. Calendar scanning module 320 may scan a calendar 395 associated with the user. The calendar may be scanned for the temporally relevant appointment. Additionally, calendar scanning module 320 may identify connection information associated with the temporally relevant appointment. The connection information may describe, for example, how to connect system 300 to a call, teleconference, or other communication technology associated with the temporally relevant appointment. Thus the connection information may include, for example, an application identifier, a phone number, a conference room number, a username, a password, and so forth.

System 300 also includes an application initiation module 330. Application initiation module 330 may launch application 390 based on the connection information retrieved from the temporally relevant appointment. Application initiation module 330 may also control application 390 to connect to an event identified in the connection information. The event may be, for example, a meeting, call, or other form of communication associated with the temporally relevant appointment.

In some examples, system 300 may include dedicated hardware input 399, calendar 395, communication application 390, and so forth. This may occur when, for example, system 300 is a computer having a variety of applications installed thereon, including a variety of peripherals, input devices, and so forth that perform a variety of functions in accordance with examples described herein. By way of illustration, a laptop that corresponds to system 300 may include a key on the keyboard that corresponds to dedicated hardware input 399, a calendar and/or email application data that corresponds to calendar 395, a voice over internet protocol application (among others) that corresponds to communication application 390, and so forth.

In some examples, listening module 310 may also detect a control from the user via a dedicated hardware termination input. This control may indicate the user seeks to terminate communication application 390. Consequently, subsequent to receiving the control, listening module 310 may control termination of communication application 390.

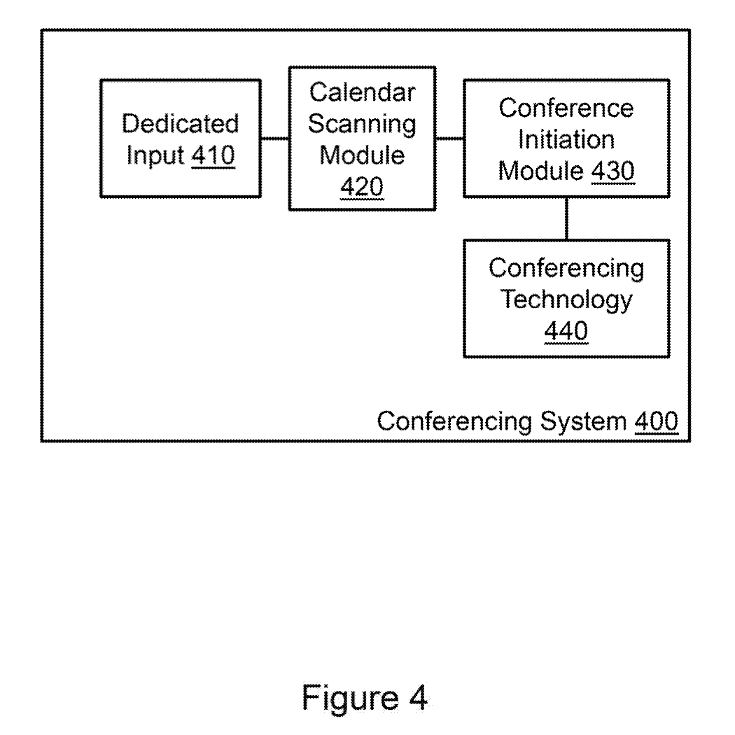

FIG. 4 illustrates a conferencing system 400. In some examples, conferencing system 400 may be embedded in conference room. Conferencing system 400 includes a conferencing technology 440. Conferencing technology 440 may be one of a videoconferencing system, a teleconferencing application, a voice over internet protocol application, a telephone application, and so forth. By way of illustration, a conference room may include dedicated conferencing equipment and technology configured to connect the conference room to other compatible conference rooms, systems, and so forth. The conferencing equipment and technology may include, for example, computers having applications installed thereon to control displays and/or projectors within the conference room. The computer may be controlled via input devices such as touch pads, keyboards, and so forth within the conferencing system.

Conferencing system 400 also includes a dedicated input to receive a user input indicating the user seeks to activate the conference technology. The dedicated input may be a button on a control device within the conference room.

Conferencing system 400 also includes a calendar scanning module 420. Calendar scanning module 420 may scan a calendar associated with the conference system for a temporally relevant appointment. The temporally relevant appointment may be an appointment that is past its scheduled initiation time, an appointment with an impending initiation time, and so forth. Additionally, calendar scanning module 420 may identify connection information associated with the temporally relevant appointment. In examples, where conferencing system 400 is installed in a conference room, the calendar associated with the conference system may be based on a room reservation associated with the conference room.

Conferencing system 400 also includes a conference initiation module 440. Conferencing initiation module may initiate the conferencing technology with parameters defined by the connection information.

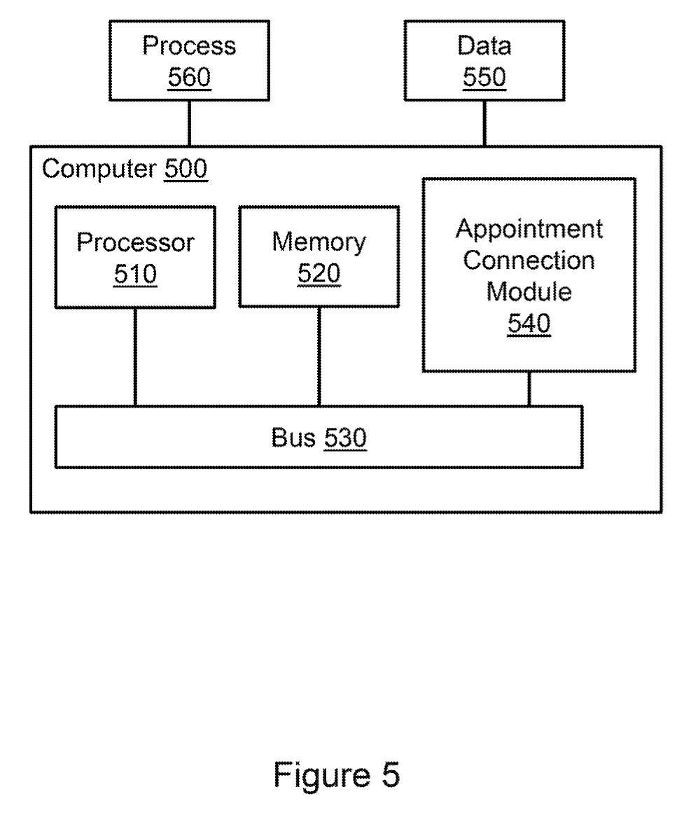

FIG. 5 illustrates an example computing device in which example systems and methods, and equivalents, may operate. The example computing device may be a computer 500 that includes a processor 510 and a memory 520 connected by a bus 530. Computer 500 includes an appointment connection module 540. Appointment connection module 540 may perform, alone or in combination, various functions described above with reference to the example systems, methods, and so forth. In different examples, appointment connection module 540 may be implemented as a non-transitory computer-readable medium storing processor-executable instructions, in hardware, software, firmware, an application specific integrated circuit, and/or combinations thereof.

The instructions may also be presented to computer 500 as data 550 and/or process 560 that are temporarily stored in memory 520 and then executed by processor 510. The processor 510 may be a variety of processors including dual microprocessor and other multi-processor architectures. Memory 520 may include non-volatile memory (e.g., read only memory) and/or volatile memory (e.g., random access memory). Memory 520 may also be, for example, a magnetic disk drive, a solid state disk drive, a floppy disk drive, a tape drive, a flash memory card, an optical disk, and so on. Thus, memory 520 may store process 560 and/or data 550. Computer 500 may also be associated with other devices including other computers, devices, peripherals, and so forth in numerous configurations (not shown).

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

What is claimed is:

1. A method, comprising:
receiving an unprompted signal from a dedicated hardware input, where the dedicated hardware input is associated with initiating a call;
scanning a calendar for a temporally relevant appointment;
scanning the temporally relevant appointment for connection information regarding the appointment; and
controlling establishing a connection associated with the temporally relevant appointment using the connection information.

2. The method of claim 1, where the temporally relevant appointment is one of an appointment that is past its scheduled initiation time, and an appointment with an impending initiation time.

3. The method of claim 1, where the connection information is one of a telephone number, an email address, conferencing information, a uniform resource locator (URL) address, and an application identifier.

4. The method of claim 1, where controlling establishing the connection includes launching an application with parameters that cause the application to establish the connection.

5. The method of claim 1, comprising upon detecting conflicting appointments, providing an interface for selecting the temporally relevant appointment.

6. The method of claim 1, comprising terminating the connection upon receiving a signal from a dedicated hardware termination input.

7. The method of claim 1, where the dedicated hardware input is a key on a keyboard whose function has been defined based on an application installed on a system to which the keyboard is attached.

8. A system, comprising:
a listening module to detect a control from a user via a dedicated hardware input indicating the user seeks to activate a communication application associated with a temporally relevant appointment;
a calendar scanning module to scan a calendar associated with the user for the temporally relevant appointment and to identify connection information associated with the temporally relevant appointment; and
an application initiation module to launch the communication application based on the connection information and to control the application to connect to an event identified by the connection information.

9. The system of claim 8, where the communication application is one of, a voice over internet protocol (VoIP) application, a chat application, a teleconferencing application, a video conferencing application, and a telephone application.

10. The system of claim 8, where the system comprises the calendar, the communication application, and the dedicated hardware input.

11. The system of claim 8, where the listening module further detects a control from a user via dedicated hardware termination input indicating the user seeks to terminate the communication application.

12. A conferencing system, comprising:
a conferencing technology;
a dedicated input to receive a user input indicating the user seeks to activate the conference technology;
a calendar scanning module to scan a calendar associated with the conference system for a temporally relevant appointment and to identify connection information associated with the temporally relevant appointment; and
a conference initiation module to initiate the conferencing technology with parameters defined by the connection information.

13. The conference room of claim 12, where the conferencing technology is one of a videoconferencing system, a teleconferencing application, a voice over internet protocol application, and a telephone application.

14. The conference room of claim 12, where the temporally relevant appointment is one of an appointment that is past its scheduled initiation time, and an appointment with an impending initiation time.

15. The conference room of claim 12, where the conferencing system is embedded in a conference room, and where the calendar associated with the conference system is based in part on a room reservation system associated with the conference room.
